(19) United States
(12) Patent Application Publication
(10) Pub. No.: US 2015/0352473 A1
(43) Pub. Date: Dec. 10, 2015

(54) MOBILE DEVICE FOR FILTERING LIQUID UNDER PRESSURE

(71) Applicant: Pierre MARCONI, (US)

(72) Inventor: Pierre MARCONI, Shanghai (CN)

(21) Appl. No.: 14/759,223

(22) PCT Filed: Dec. 20, 2013
(86) PCT No.: PCT/EP2013/077685

§ 371 Date: Jul. 3, 2015

(30) Foreign Application Priority Data
Jan. 10, 2013 (FR) 1300037

(51) Int. Cl. B01D 35/027; C02F 1/00; B01D 35/30

(52) U.S. Cl. CPC B01D 35/0276; B01D 35/30; B01D 35/306; C02F 1/003; C02F 2201/002; C02F 2201/008

(57) ABSTRACT

A device for filtering liquid, including a first reservoir for collecting filtered liquid, a second reservoir for liquid to be filtered, the second reservoir contained at least partially in the first reservoir, the walls of said second reservoir having at least a filtering opening allowing transfer of liquid between the first and second reservoirs, an injection opening having a filter blocking the filtering opening, and a flexible pressurization device to inject air into the second reservoir via the injection opening. The pressurization device is located completely outside the second reservoir, and has a volume that is variable between two positions: a deployed position, in which the volume of the pressurization device is maximal, and a folded position, in which the volume of the pressurization device is minimal.

### TECHNICAL FIELD OF THE INVENTION

The field of the invention is that of systems for filtering liquid under pressure, intended in particular to be used for purifying water by passage under pressure through a filter of the ceramic type.

In particular, the invention relates to a compact self-contained filtration device suitable for being easily transported daily, while taking into account the maintenance of good hygiene and optimisation of the purification process.

### TECHNOLOGICAL BACKGROUND

Essential to life, water is a resource of prime importance. Despite the vital requirement that it constitutes for every individual, water is also a significant carrier of illnesses, and problems related to access for everyone to good-quality water remains a major challenge to be dealt with at this start of the 21st century.

On an individual scale, various means are used daily to purify water. Thus US 2010/0237002 describes a personal filtration device that can be fitted sealingly on the spout of a tap. The water expelled under pressure from the pipe is thus filtered by passing through a filter before being poured into a bottle. Use of this device therefore requires the user to be in the immediate vicinity of a specific water supply source, in this case a tap, which limits its mobility. In addition, the device does not comprise a means for storing filtered water. The filtered water is therefore intended to be consumed immediately or stored in an external receptacle, without preventing potential contamination of the water during transfer into it.

Other more complex methods make it possible to overcome these difficulties.

Thus US 2010/0200489 describes a pressurised water filtering carafe comprising two water reservoirs. The first reservoir is fitted into the second so that the transfer of water from one reservoir to the other can be effected only by passing through a filter, itself consisting of a superimposition of filtering layers. The carafe is made airtight by the fitting of a lid on which a pressurisation device is fitted in the form of a piston. By activating the piston, the user injects air into the carafe, which accelerates the process of filtration of the water contained in the first reservoir. The major drawbacks of this carafe are related to the introduction of the piston into the first receptacle, which increases the risks of contamination of the piston by pathogens, as well as the rigid nature and the complexity of the piston, making the latter more difficult to produce but also more fragile.

Other methods comprising a pressurisation device arranged outside the receptacle collecting water to be filtered partly overcome these difficulties. However, the means developed have the common feature of being detrimental to the overall compactness of the filtration device, which constitutes a prohibitive obstacle with regard to the industrial applications targeted by the invention.

### OBJECTIVES OF THE INVENTION

The invention aims to overcome at least some of the drawbacks present in the prior art.

In particular, the invention aims to provide a device for filtering liquid under pressure that is not complex and combines good self-containment of use, robustness to external impacts and maintenance of good hygiene, while keeping maximum compactness in order to be able to be stored or transported easily.

The invention also aims to provide, at least in one embodiment, a filtration device that can easily be assembled and disassembled, in order to facilitate the transport and cleaning of the device and the charging of it with water to be filtered.

The invention also aims to provide, in at least one embodiment, a filtration device inside which a filter can be fitted in the form of a cartridge or allowing the implementation of an ultrafiltration method.

The invention also aims to provide, in at least one embodiment, a filtration device enabling the user, after loading of the water to be filtered, to initiate the filtration method when he so wishes.

### DISCLOSURE OF THE INVENTION

These objectives, as well as others that will emerge more clearly hereinafter, are achieved by means of a liquid-filtration device comprising:
a first receptacle intended to collect the filtered liquid,
a second receptacle intended to contain the liquid to be filtered, said second receptacle being contained at least partly in said first receptacle, the walls of said second receptacle having at least two openings: a filtration opening, suitable for transferring liquid between said first and said second reservoir, and an injection opening,
a filter closing off said filtration opening,
a pressurisation device for injecting air into said second receptacle through said injection opening, characterised in that said pressurisation device is a flexible device, completely located outside said second receptacle, and occupying a variable volume between two positions:
a deployed position in which the volume occupied by the pressurisation device is at a maximum,
a folded position in which the volume occupied by the pressurisation device is at a minimum, and in that said folded position is, in the absence of any action by a user, a stable position.

Throughout the text, the term “flexible” describes the ability of an object to fold without breaking.

A filtration device according to the invention confers on the user good self-containment of use, comprising within its structure means for storing and filtering the targeted liquid. Thus the first and second reservoirs respectively contain the filtered liquid and the liquid to be filtered. The user is therefore not subjected to the need to be situated close to a liquid-supply source in order to operate the device, nor to use a third collecting receptacle to collect the filtered liquid. The presence of a pressurisation means for its part accelerates the filtration method. This pressurisation means being located outside the second receptacle, the introduction of foreign bodies inside the second receptacle or the pressurisation device, and therefore the risks of contamination that are related thereto, are thus limited. This is because, in the contrary hypothesis, putting the pressurisation means in contact with the liquid to be filtered contained in the second receptacle would increase the probability of a mutual exchange of pathogens. A first loading of liquid to be filtered could for example initially contaminate the pressurisation device before the latter in its turn contaminates a second load of liquid to be filtered, thereby making the action of the filter more complex. The location of the pressurisation device outside the second receptacle therefore limits these detrimental effects as well as the constraints related to the cleaning of the pressurisation device. According to the invention, the pressurisation device is, in the absence of action by the user, in a stable position in which the space occupied by pressurisation device is at a minimum. The filtration device therefore has, when it is at rest, maximum compactness, which facilitates its placing in a small space for purposes of storage or transport. The compactness of the pressurisation device and its flexible character are also indications of reinforcement of the whole of the structure, enabling the pressurisation device to better withstand the external mechanical impacts that may be caused. The filtration device is therefore more robust.

According to a particular feature, the filtration device comprises a seal, fitted on the second receptacle so as to close off the injection opening, and allowing only a unidirectional passage of air, from the outside to the inside of said second receptacle.

Thus the seal does not enable air or liquid to be transferred from the second receptacle to the pressurisation device, in particular between the various phases of injection of air from the pressurisation device into the second receptacle. The pressure equilibrium inside the second receptacle is achieved by transferring liquid from the second receptacle to the first, by means of the filter. The action of the pressurisation device on the filtration process is therefore reinforced by the arrangement of the seal. The seal also limits contamination of the pressurisation device by the second receptacle, which has the technical effect of improving the hygiene of the filtration device, reducing the costs of cleaning the pressurisation device and increasing the service life of the latter.

According to this particular feature, the seal is fitted removably on the second receptacle.

Thus the seal can be removed from the second receptacle by the user so as to allow the loading of liquid to be filtered from the second receptacle, the cleaning of the device or the replacement of a defective part.

According to a particular feature, the filtration device comprises a cover protecting the pressurisation device.

Thus the resistance of the pressurisation device to external mechanical impacts is increased. The filtration device is therefore more robust.

According to this particular filter, the filtration device comprises means for the removable fixing of the protective cover on the second receptacle.

Thus, when the protective cover is arranged with the second receptacle, it enables the filtration device to have an additional sealing means while increasing the robustness of the filtration device.

According to a particular feature, the filtration device comprises means for the removable fixing of said pressurisation device on the second receptacle.

Thus, when the pressurisation device is arranged on the second receptacle, it enables the filtration device to have an additional sealing means while reinforcing the robustness of the filtration device. In addition, the removable character of this fixing means enables a user to be able to remove these various parts for the purpose of facilitating transport thereof, maintenance thereof or the charging of the second receptacle with liquid.

According to a particular feature, the filter is at least partly made from ceramic and has a hollow tubular shape, closed on a first end, a second end closing off said filtration opening.

Filtration by ceramic filter is in general extremely fine, around 0.2 microns, because of the miniscule pores that constitute its microstructure. The use of a ceramic filter thus makes it possible to stop microorganisms that are hazardous for health, such as viruses or bacteria. It can also be envisaged combining ceramic filtration with a traditional chemical treatment, which eliminates additional chemical components that may be dissolved in the filtered liquid. The conformation of the filter “in a cartridge” for its part maximises the filtering surface in contact with the liquid to be filtered, for the purpose of increasing the efficiency of the filter. It may also be envisaged using a filter that is impermeable to air, so that only liquid fluids can pass through. Thus the filtration process can remain effective in the case of partial immersion of the filter in the liquid to be filtered.

According to a particular feature, the size of the pores of at least one membrane of said filter is between 0.1 and 0.001 microns.

When the size of the pores of a ceramic filter is between 0.1 and 0.001 microns, ultrafiltration is spoken of. Unlike a conventional filtration, which limits the passage of large molecules by retaining them in its lattice of pores, ultrafiltration blocks the impurities at the entry to the lattice, allowing only molecules of very small size to pass. These impurities can then be eliminated by the dynamic effect of the fluid in local contact with the filter or following simple cleaning. Consequently the efficiency of the filter and its service life are considerably increased, the risks of bacterial contamination inside the filter are reduced and cleaning is made easier. On the other hand, because of the reduction in the size of the pores, the functioning of this method requires the existence of a pressure differential between the walls of the filter, which justifies the use of a pressurisation means in the context of the invention.

According to a particular feature, the filtration device comprises an opening for discharging the filtered liquid, closed off in the folded position.

Thus the closure of the discharge opening when the filtration device is at rest ensures the fluidtightness of the first receptacle and limits the risks of bacterial contamination of the filtered water contained in said receptacle.

According to a particular feature, the second receptacle is divided into two compartments by a sealed partition that comprises in its upper part an opening able to allow decanting of said liquid from one of said compartments to the other, by tilting said filtration device in a lateral direction.

In the case of a first compartment arranged so as to collect the liquid loaded into the filtration device and a second compartment comprising the filtration opening and the associated filter, the user has the ability, through the decanting of the liquid from the first to the second compartment, to initiate the filtration process according to his convenience and, if necessary, for a long time after the water has been loaded into the filtration device. The risks of bacterial proliferation that may result from prolonged stagnation of the filtered water in the first reservoir are thus limited.

### LIST OF FIGURES

Other features, aims and advantages of the invention will emerge from a reading of the following description that presents, by way of non-limitative example, an embodiment of the invention, with reference to the accompanying drawings; in these drawings:

FIG. 1 is a telescoped view in perspective of the filtration device,

FIG. 2 is a schematic view of the ceramic filter,

FIG. 3 is a schematic view of the filtration device in the folded position, after loading of the liquid,

FIG. 4 is a schematic view of the filtration device in the deployed position,

FIG. 5 is a schematic view of the filtration device in the folded position, after filtration of the liquid,

FIG. 6a is a schematic view of the first reservoir in the position of loading of the first compartment with liquid,

FIG. 6b is a schematic view of the first reservoir in the position of decanting liquid from the first compartment to the second,

FIG. 6c is a schematic view of the first reservoir in the position of initiation of the filtration process.

### DETAILED DESCRIPTION OF AN EMBODIMENT OF THE INVENTION

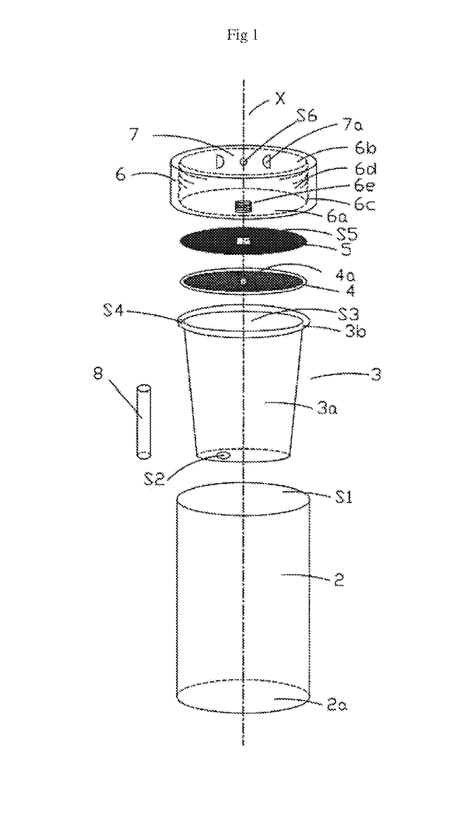

In the figures, the scales and proportions are not strictly complied with, for purposes of illustration and clarity. Throughout the detailed description that follows with reference to the figures, unless indicated to the contrary, each element of the filtration device is described as arranged when the base of the first receptacle is mounted horizontally. This arrangement is in particular shown in FIGS. 1, 3, 4, 5, 6a and 6c.

In FIGS. 1, 3, 4 and 5, the filtration device 1 comprises a first receptacle 2, having the form of the lower portion of a bottle, provided on its lower part with a base 2a enabling it to be placed in a stable manner on a flat surface, and, on its upper part, with an open cross section S1, oriented on a substantially horizontal plane. With the objective of facilitating handling thereof by a user, the first receptacle 2 may comprise, on at least one of its lateral walls, a handle, with non-slip surfaces, or an ergonomic design allowing easy gripping of the first receptacle 2 by hand. A second receptacle 3 is composed of a reservoir 3a, with a volume at least less than half that of the first receptacle 2, having, on one of its walls, an opening referred to as the filtration opening S2 and, on its upper part, an open cross section S3, oriented on a substantially horizontal plane, and having on its external circumference a collar 3b. This collar 3b is sized so as to cover the whole of the circumference of the open cross section S1 when the reservoir 3a is introduced into the first receptacle 2. The first receptacle 2 is then hermetically closed by the second receptacle 3 with the exception of the filtration opening S2 and a discharge opening S4 provided in the collar 3b. A seal 4 is arranged removably, by screwing, on the upper part of the second receptacle 3, so as to close off its open cross section S3. This seal 4 comprises at its centre a valve 4a that allows the passage of air only from the outside to the inside of the second receptacle 3. A cap 5 is fitted removably on the seal 4 so as to be able to protect the latter from any external mechanical impacts. This cap 5 has at its centre an opening S5 enabling air to pass.

The filtration device 1 also comprises a pressurisation device 6 comprising a first seal referred to as the injection seal 6a and a second seal referred to as the loading seal 6b, both placed in substantially horizontal planes and separated from each other by a flexible tubular-shaped element 6c, extensible mainly in a vertical direction and delimiting, with the injection seal 6a and the loading seal 6b, a hermetic cavity 6d of variable volume V. The loading seal 6b and the injection seal 6a each comprise at their centre a valve allowing only a unidirectional passage of air and allowing respectively the entry and exit of air to and from the cavity 6d. A compressing spring 6e connecting the respective centres of the injection seal 6a and the loading seal 6b tends to oppose the moving away of the two seals. A protective cover 7, concave in shape and having an open cross section substantially identical to S1, is fixed, with its cavity oriented downwards, on the external face of the loading seal 6b. The protective cover 7 has an opening S6, allowing a passage of air, the centre of which is included in the axis X defined by the respective centres of the injection seal 6a and the loading seal 6b. The distance D separating the injection seal 6a from the loading seal 6b varies, according to the movement of the latter, along the axis X, between two positions: a so-called folded position, characterised in that the distance D reaches its minimum value, and a so-called deployed position, characterised in that the distance D reaches its maximum value. The extreme values taken by the distance D are determined by the capacity of the tubular-shaped flexible element 6c to extend and contract along the axis X. The volume V being proportional to the distance D, the volume V therefore reaches its minimum and maximum values in the positions respectively folded and deployed. The movement of the loading seal 6b with respect to the injection seal 6a along the axis X is governed by the work of the extension force exerted by the user and the return force exerted by the compressing spring 6e. The protective cover 7 comprises, on its external face, grips 7a enabling the fingers of the user to have a better grip. The pressurisation device 6, in the absence of the action of a user, tends to return to the folded position under the effect of the compressing spring 6e. The external face of the injection seal 6a is arranged by a fixing by removable screwing on the collar 3b, so that the respective centres of the open sections S3 and S5 and of the valve 4a are aligned along the axis X. The protective cover 7 and the collar 3b are, when the pressurisation device 6 is in the folded position, fixed removably by the use of opposite polarisation magnets.

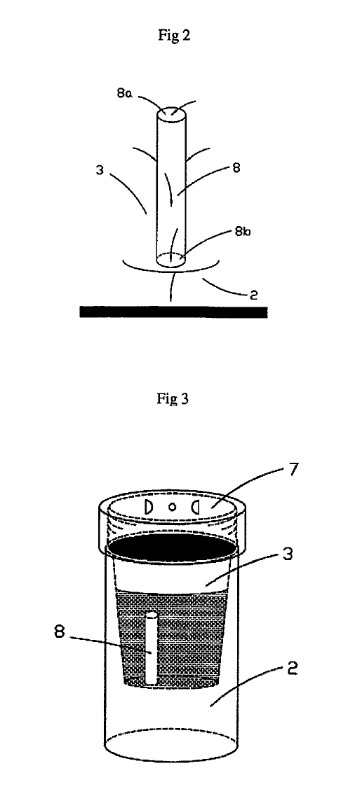

In FIG. 2, the ceramic filter 8 has a hollow tubular form, closed on a first end 8a, a second end 8b closing off said filtration opening S2. The filter 8 is fixed removably to the bottom of the second receptacle 3, by means of screwing, so that the whole of the filter 8 is contained in the second receptacle 3. The filter 8 is intended for the filtration of water, with a mean capacity of 5000 litres, according to the quality of the water to be filtered and the frequency of cleaning of the filter 8.

In the following description of the filtration process, the targeted liquid is water. However, according to other embodiments, the water is replaced by another liquid and the filter is adapted accordingly.

In the text, the removable fixing means described are screwing systems. However, according to other embodiments, screwing systems are replaced by push-in systems or clips. The latter have in particular the advantage of adapting to non-circular shapes. It is the elasticity of the material that then ensures the closure and sealing.

The various operating phases of the filtration device 1 are described below in their chronological order of use.

During the phase of loading with water, the pressurisation device 6, the cap 5 and the seal 4 are disengaged so as to free up access to the reservoir 3a of the second receptacle 3. The user then fills the reservoir 3a with water. Once the filling is effected, the seal 4, the cap 5 and the pressurisation device 6 in the folded position are rearranged on the rest of the filtration device 1, as depicted by FIG. 3.

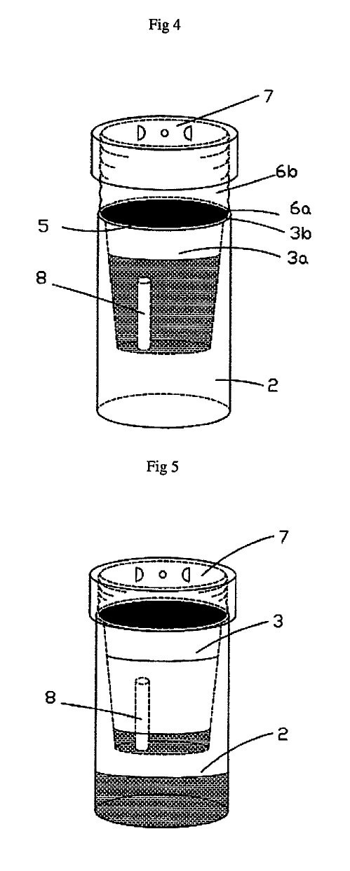

During the phase of loading with air, the user produces a tension force on the pressurisation device 6, via the grips 7a, and tends to move the loading seal 6b away from the injection seal 6a by translation along the axis X. This work opposes that of the compressing spring 6e. The volume V of the cavity 6d increases proportionally to the distance D, giving rise to a pressure differential between the inside and outside of the cavity 6d that in its turn causes the valve of the loading seal 6b to open and air to enter inside the cavity 6d. Once the pressurisation device 6 is in the deployed position, as depicted by FIG. 4, the pressure differential decreases, causing the closure of the valve of the loading seal 6b.

During the filtration phase, the user produces a compression force on the pressurisation device 6 and tends to move the loading seal 6b closer to the injection seal 6a by translation along the axis X. This work is added to that of the compressing spring 6e. The volume V of the cavity 6d decreases proportionally to the distance D, causing a pressure differential between the inside and outside of the cavity 6d that in its turn causes the opening of the valve of the injection seal 6a and of the valve 4a, and the transfer of air from the cavity 6a to the reservoir 3a of the second receptacle 3. The addition of air in the second receptacle 3 causes a pressure differential between the first receptacle 2 and the second receptacle 3, which causes a transfer of water, from the second receptacle 3 to the first receptacle 2, through the filter 8. Once the pressurisation device 6 is in the folded position, the pressure differential decreases, causing the closure of the valve of the injection seal 6a. The transfer of water from the second receptacle 3 to the first receptacle 2 continues until the pressure differential between the two receptacles reaches a limit value, depending on the characteristics of the filter 8, marking the stoppage of the filtration process. At the end of the injection phase, as depicted by FIG. 5, the pressurisation device 6 is in the folded position, closing the discharge opening S4.

It is then for the user to empty the first receptacle 2 by inclining the filtration device and extending the pressurisation device 6 so as to leave clear the discharge opening S4 and thus enable the filtered liquid to be discharged from the first receptacle 2.

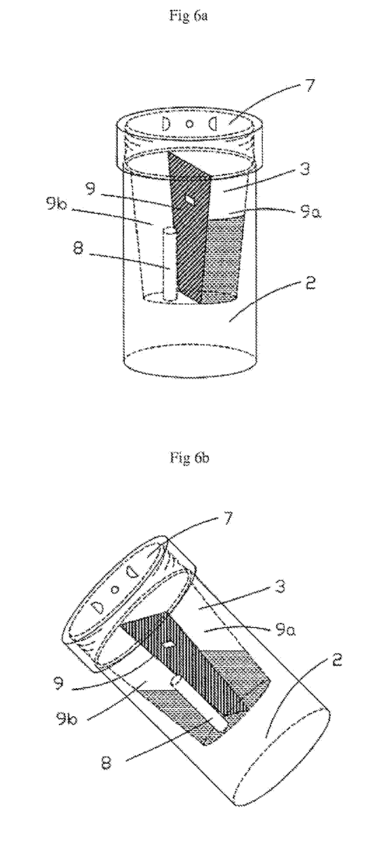

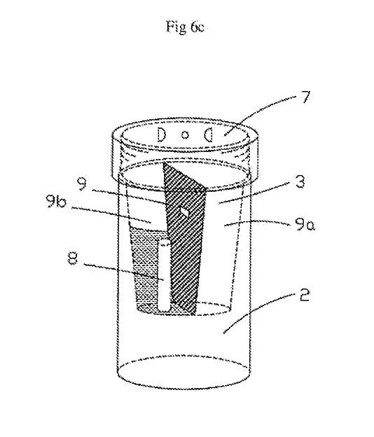

According to another embodiment and as depicted by FIGS. 6a, 6b and 6c, the second receptacle 2 is divided into two compartments by a sealed partition 9 that comprises an opening S5 in its upper part. The first compartment 9a is intended to collect the water loaded into the filtration device by the user. The second compartment 9b has the filtration opening S2 around which the filter 8 is fixed. During the loading phase and as depicted by FIG. 6a, the water is introduced into the compartment 6a by the user. During the decanting phase and as depicted by FIG. 6b, the filtration device is inclined by the user so as to enable the water initially contained in the first compartment 9a to be transferred into the second compartment 9b. During the phase of initiation of the filtration process and as depicted by FIG. 6c, the water transferred into the compartment 6c is in a position to be filtered. The various operating phases of the filtration device 1 can then be implemented as described above.

Various types of material make up the filtration device 1. Thus the seals 4, 6a, 6b and the extensible tubular-shaped tube 6d are made from rubber, because of its impermeability and its good elasticity. The other parts constituting the filtration device 1, apart from the filter, are made from plastics material, because of the lightness, the low production costs, the low chemical reactivity and the good impact resistance of this material. However, according to another embodiment, the walls of the first receptacle 2 and of the protective cover 7 are made from aluminium, because of the low thermal conduction of this material. The device embodied according to this filtration mode thus has better ability to preserve the coolness or warmth of the treated liquid.

1. Filtration device comprising:
a first reservoir adapted to collect filtered liquid,
a second reservoir adapted to contain liquid to be filtered, said second reservoir being contained at least partly in said first reservoir, walls of said second reservoir having at least two openings: a filtration opening, suitable for transferring liquid between said first and said second reservoir, and an injection opening,
a filter closing off said filtration opening,
a pressurization device for injecting air into said second reservoir through said injection opening, such that said pressurization device is a flexible device, completely located outside said second reservoir, and occupying a variable volume between two positions:
a deployed position in which the volume occupied by the pressurization device is at a maximum,
a folded position in which the volume occupied by the pressurization device is at a minimum,
and wherein said folded position is, in the absence of any action by a user, a stable position.

2. Filtration device according to claim 1, further comprising a seal fitted on the second reservoir so as to close the injection opening and allow only a unidirectional passage of air from an outside to an inside of said second reservoir.

3. Filtration device according to claim 2, wherein said seal is removably fitted on the second reservoir.

4. Filtration device according to claim 1, further comprising a protective cover for the pressurization device.

5. Filtration device according to claim 4, further comprising means for the removable fixing of said protective cover on said second reservoir.

6. Filtration device according to claim 1, further comprising means for the removable fixing of said pressurization device on said second reservoir.

7. Filtration device according to claim 1, wherein said filter is at least partly made from ceramic and has a hollow tubular shape, closed on a first end, and a second end adapted to close said filtration opening.

8. Filtration device according to claim 1, wherein the size of the pores of at least one membrane of said filter is between 0.1 and 0.001 microns.

9. Filtration device according to claim 1, wherein said filtration device comprises an opening for discharging filtered liquid, which opening is closed in said folded position.

10. Filtration device according to claim 1, wherein said second reservoir is divided into two compartments by a sealed partition that comprises, in its upper part, an opening able to allow the decanting of said liquid from one of said compartments to the other, by tilting said filtration device in a lateral direction.
